(19) United States
(12) Patent Application Publication
(10) Pub. No.: US 2016/0078458 A1
(43) Pub. Date: Mar. 17, 2016

(54) SYSTEM OF POLL INITIATION AND DATA COLLECTION THROUGH A GLOBAL COMPUTER/COMMUNICATION NETWORK AND METHODS THEREOF

(71) Applicants: Zara A. Gold, Edgewater, NJ (US); Zachary N. Gold, Edgewater, NJ (US)

(72) Inventors: Zara A. Gold, Edgewater, NJ (US); Zachary N. Gold, Edgewater, NJ (US)

(21) Appl. No.: 14/949,561

(22) Filed: Nov. 23, 2015

Related U.S. Application Data
(63) Continuation-in-part of application No. PCT/US2014/039591, filed on May 27, 2014.
(60) Provisional application No. 61/827,339, filed on May 24, 2013.

(51) Int. Cl. G06Q 30/02

(52) U.S. Cl. CPC G06Q 30/0203

(57) ABSTRACT

A computer-implemented method of public opinion poll initiation and public opinion data collection for using non-deterministic mathematical models (e.g. chaos model), independent of third parties involvement (e.g., campaign managers, marketers, pollsters, etc.) is provided. In exemplary embodiments, the method may comprise receiving a post and an instruction for public opinion poll from a first user; initiating the public opinion poll and displaying it to a second user(s)/the public, receiving an initial answer to the public opinion poll from the second user(s); generating results of the public opinion poll based on the initial answer; receiving an alternative answer(s) from the second user(s) if wished by the second users, updating the results of the public opinion poll based on the alternative answer(s); and displaying a real-time feed of the public opinion poll results, the real-time feed updated when public opinion poll answers are entered or changed by a user.

### CROSS-REFERENCE TO RELATED APPLICATIONS

The present application claims priority to U.S. Provisional Patent Application Ser. No. 61/827,339 entitled “System of Poll Initiation and Data Collection Through A Global Computer/Communication Network and Methods Thereof,” filed May 24, 2013, the disclosure of which is incorporated herein by reference in its entirety as if fully set forth herein. This application is a continuation-in-part of International Application No. PCT/US2014/039591 filed on May 27, 2014.

### BACKGROUND

1. Field of the Invention

Embodiments of the present invention generally relate to system of poll initiation and data collection through a global computer/communication network and methods thereof. More specifically, embodiments of the present invention relate to a non-deterministic mathematical model for initiating and conducting opinion polls and collecting public opinion data in a real-time feeding system based on the chaos mathematical model, wherein the poll questions and votes are available to the public in real time, independent of third parties' involvement for initiating polls.

2. Description of Related Art

Measuring public opinion is rightfully considered to be a unique combination of art and science. While polling industry delivered reliable results in previous decades, the most recent systematic failures in polls highlights its limitation in the age of information revolution, where 98% of the world contents were made in the past two years and individuals' opinions quickly change as they consume more information in their networks. Today's opinions are now the last minute reactions to receiving information compared to the past opinions that were made of convictions, making them predictable from past behaviours. The current situation also questions the credibility of market research, if people's actions do not follow people's intentions. This invention addresses the current limitations by providing live public opinion data in a peer-to-peer engagement where participants own their expressed opinions/votes and able to change them or withdraw from the process when desired.

An opinion poll or “poll” typically is a survey of public opinion from a particular sample. Traditional Opinion polls are designed to evaluate the opinions of a population by conducting polls, asking a series of questions in selected representative samples and then extrapolating generalities to population in ratio or within confidence intervals. Traditional polling is initiated by a third party (i.e. research institution, campaign manager, marketing firm, academia, etc.) and poll questions are usually formed by such parties. Traditional polling is based on the concept of a “deterministic” model where future behavior is assumed to be predicted precisely from the past behavior of a set of data. The methods that are applied in traditional polling ignore the existence of disturbances or external ‘shocks’ that may alter the data's future pattern. Traditional methods involve third party (i.e. media, academia, campaign managers, marketers, research institution, etc.) for initiating a survey, whereas an approach consistent with embodiments of the present invention allow a peer-to-peer style of collecting live opinion data by public initiation and public engagement.

Further, traditional methods of collecting data are based on ‘hard’ or non-changeable votes in traditional surveys, wherein a survey taker may not change his or her vote after the vote is cast. Traditional methods do now allow the collection of votes in a ‘soft’ or ‘fluid’ form and have no way of presenting “real-time” or substantially “real-time” data. Traditional methods also do not allow poll takers to retract and/or take back their casted votes and disengage from the question, poll, or the like. Systems and methods in accordance with exemplary embodiments of the present invention allow volunteering public engagement for initiating polls as well as volunteering engagement of public for voicing opinions and casting votes. The casted votes in the systems and methods in accordance with exemplary embodiments can be changed as often as desired by the voter, making the vote as a ‘soft’ or ‘fluid’ vote as opposed to a hard conviction of the casted votes in traditional polling. The exemplary systems and methods of the present disclosure also allow a voter to take his/her casted vote back and disengage as desired. The systems and methods of the present disclosure allow for user anonymity or a change of anonymity of any/all parties involved at any time and as often as desired.

Thus a need exists for a system and/or method comprising “real-time” or substantially “real-time” public opinion data collected from peer-to-peer anonymous sources in a non-deterministic model wherein the users may change their answer to a poll as many times as they would like and/or retract an answer to a poll, or the like.

### SUMMARY

Embodiments of the present disclosure generally relate to a computer-implemented method of poll initiation and data collection. In one embodiment, a computer-implemented method of poll initiation and data collection may comprise at a server having one or more processors and memory storing one or more programs for execution by the one or more processors; receiving a poll initiation (post) from a first user; receiving a poll instruction (i.e. based on locality, age demographic data) from the first user; initiating the poll by displaying it to the public; receiving an casted votes from the interested or qualified public; and displaying a real-time feed of the public opinion; and the continuous updated of the real-time public feed new votes are casted or existing votes change.

In another embodiment of the present disclosure, a computer-implemented method of poll initiation and data collection may comprise at a server having one or more processors and memory storing one or more programs for execution by the one or more processors receiving a public opinion poll from a first user; receiving a public opinion poll locality from the first user; receiving an instruction for expiration time for the poll from the first user or leaving it as an open poll with no definite time for expiration. The initial instruction (i.e. expiration time of the poll, age, locality, etc.) for setting a poll may be changed by the first user as desired.

In yet another embodiment of the present disclosure, a system may comprise at least one server that may comprise one or more processors; and memory; wherein the at least one server is adapted to receive a public opinion poll from a first user; receive a public opinion poll locality from the first user; initiate the public opinion poll and displaying the public opinion poll to a second user, the second user residing within the public opinion poll locality; receive an initial answer to the public opinion poll from a second user; generate results of the public opinion poll based on the initial answer; receive a second answer from the second user, the second answer different from the initial answer; update the results of the public opinion poll based on the second answer; and display a real-time feed of the public opinion poll results, the real-time feed updated when public opinion poll answers are entered or changed by a user.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a block diagram of an exemplary system in accordance with one embodiment of the present disclosure;

FIG. 2 depicts a block diagram of a general computer system in accordance with one embodiment of the present disclosure;

FIG. 3 depicts a flowchart of a method of poll initiation and data collection utilizing an exemplary embodiment in accordance with embodiments of the present invention;

FIG. 4 depicts a block diagram illustrating a system of poll initiation and data collection in accordance with embodiments of the present invention;

FIG. 5 depicts an exemplary client computer capable of being used with a system of poll initiation and data collection in accordance with embodiments of the present invention;

FIG. 6 depicts an exemplary user interface for use with a system of poll initiation and data collection in accordance with embodiments of the present invention; and

FIG. 7 depicts an exemplary display comprising a ticker displaying the results of data collected with a system of poll initiation and data collection in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a Butterfly Effect In Public Opinion (hereinafter “BEIPO™”) system of poll initiation and data collection through a global computer/communication network and methods thereof. More specifically, embodiments of the present invention relate to a system and method adapted to allow a user to feed the system either by voting or initiating one or more polls in real-time. The system may be adapted to collect and present data in accordance with parameters selected by the user.

In the following detailed description, numerous specific details are set forth in order to provide a thorough understanding of exemplary embodiments or other examples described herein. However, it will be understood that these examples may be practiced without the specific details. In other instances, well-known methods, procedures, components and circuits have not been described in detail, so as to not obscure the following description. Further, the examples disclosed herein are for exemplary purposes only and other examples may be employed in lieu of, or in combination with, the examples disclosed. It should also be noted that the examples presented herein should not be construed as limiting of the scope of embodiments of the present disclosure, as other equally effective examples are possible and likely.

As used herein, the term “poll” may refer to any type of opinion poll or data collection poll that may reasonably be construed as a survey of a particular population, subpopulation, or sample. In some embodiments, a poll may comprise questions with voting options or fields that allow some users to submit answers to the poll questions. A poll may comprise a poll conducted via a global computer/communication network or a poll conducted outside of a global computer/communication network, wherein the results are subsequently inputted into a computing device communicatively coupled with a global computer/communication network.

In accordance with certain embodiments of the present disclosure, methods disclosed herein may occur in “real-time.” Real-time is utilized herein as meaning near-instantaneous, subject to minor delays caused by network transmission and computer processing functions, and able to support various input and output data streams.

While traditional polling starts with an initiation from a third party (i.e. research institution, campaign manager, marketing firm, academia, etc.), the systems and methods in accordance with embodiments of the present invention may be independent of the third parties. In accordance with exemplary embodiments, opinion data received and/or collected by a system may be based on a peer to peer interaction. For example, any person or user may start a poll at anytime from anywhere in the world without waiting for a pollster by using one or more embodiments of the present disclosure.

The exemplary systems and methods disclosed herein differ significantly from traditional methods of collecting data in many ways. For example, traditional methods of collecting data are based on ‘hard’ or non-changeable votes in traditional surveys, wherein a survey taker may not change his or her vote after the vote is cast. In contrast, systems and methods presented herein collect votes in a ‘soft’ or ‘fluid’ form and present “real-time” or substantially “real-time” results. A ‘soft’ or ‘fluid’ form of a vote may allow any user and/or voter to retract or take the user and/or voter's vote back or change his or her vote as many times as desired as long as the poll is alive and still collecting data. This ‘soft’ or ‘fluid’ form of the vote allows a sustainable platform for collecting data on public opinion and provides maximum flexibility as people and/or users change their mind on a number of issues frequently. Therefore, in addition to allowing users to change their votes, exemplary systems and methods in accordance with the present disclosure may be configured to allow voters to retract and/or take back their casted votes and disengage from the question, poll, or the like.

In exemplary embodiments, the system and method may include and display a ticker of public opinion. The ticker may comprise a “real-time” or substantially “real-time” indication of public opinion on a poll subject that may be taken from anonymous users and initiated in a peer-to-peer method. The ticker may comprise tokenized public questions/statements, a sentiment of public opinion, and/or data indices. The system may provide public and/or private indices and/or a ticker that may be displayed in the system or available to be embedded in the websites, communication devices, billboards, or other display formats of additional parties. For example code may be provided to a third party that may integrate the indices and/or tickers generated by the present invention into the third party websites, a billboard, or an alternative display formats adapted to display the indices and or tickers, any of which may be public and/or private. Third parties, including social networks, for example, may also integrate indices and/or tickers generated by embodiments of the present invention in their platforms.

Traditionally, the collection of poll data has been based on a deterministic method of selecting a sample, collecting data from the sample, and extrapolating the results of data collection to population. The exemplary systems utilize a different approach based on different mathematical models. A mathematical model used in accordance with the present disclosure is the “chaos” model. The “chaos” model may comprise a non-deterministic approach to collecting data. The chaos mathematical model has not been used for collecting public opinion data. The chaos model may be implemented by systems in accordance with the present invention by collecting live or “real-time” opinion data as the data happens. This model allows the systems and methods presented herein to present a “snapshot” at any given moment of time of live public opinion data at that moment. The system may also allow users to change their answers or retract those answers, such that the live public opinion data may be substantially different from moment to moment. Historically, the collection of poll data is based on the concept that future behavior and opinions can be predicted precisely from past behavior indicated by a collected set of date. These methods ignore the existence of disturbances or external ‘shocks’ that may alter the data's future pattern.

Exemplary systems and methods in accordance with embodiments of the present disclosure take into account these disturbances or external ‘shocks’ that may alter the data's “real-time” and future pattern, or the like. For example, if a poll is taken and a favorable opinion data on a topic is collected and displayed by the system, in a moment's notice a ‘shock’ may occur and public opinion may change. The systems and methods in accordance with the present disclosure take these ‘shocks’ into account and present the user with “real time” or substantially “real-time” opinion data. By way of example, a favorable public opinion about a topic may be taken at a first moment in time, and at a subsequent second moment in time a ‘shock’ may occur, such as a breaking disparaging news report, or the like about the topic. After the ‘shock’ occurs, public opinion may then change to an unfavorable opinion of the topic and a system in accordance with exemplary embodiments may be adapted to display this updated poll data.

The systems and methods presented herein may allow a user to view in “real-time” the change of public opinion from a favorable opinion to an unfavorable opinion, vice versa, or the like, as a result of the ‘shock’, or the like. A ‘shock’ may generally comprise an event, or the like, that causes a change in the data. As many of ‘shocks’ are unpredictable, traditional polling methods do not accurately account for these ‘shocks’ causing disturbances in the poll data. An event may change a user's opinion of a certain topic/good/service/politician, or the like at a moment's notice. For example, a celebrity may have a favorable public opinion but then may commit a crime. The crime or the reporting of the crime may be the event or ‘shock’ and may sway public opinion in an unfavorable or favorable way. Systems and methods in accordance with the present invention may collect “real-time” data so that an accurate display of public opinion, and the change in public opinion from one moment to the next, may be captured, displayed, and/or transmitted to users. The systems and methods presented herein may be adapted to capture the change in user's votes over time, or the like.

When using traditional deterministic methods, this “real-time” data would not be collected. The collection and presentation of real-time public opinion data in an anonymous peer-to-peer format using a non-deterministic model enables users to view more accurate “real time” data. In that case, public opinion data taken at one point in time may substantially differ from public opinion data taken just a short time period later at a second point in time. As such, the systems and methods presented herein may be adapted to display a snapshot of real-time public opinion data at any point in time. The ability to retract and/or change answers to opinion polls as often or as many times as the user wishes, capture these changes or opinion swings, and display and/or transmit this data substantially differentiates the systems and methods presented herein from traditional polling methods and social network “mentions” or “trending” topics.

While typical social media platforms are focused on individual identity and sharing, the systems and methods presented herein are focused on anonymity and popularity of ideas and thoughts. The systems and methods in accordance with exemplary embodiments essentially treat ideas/thoughts/concerns/fears/joys as commodities that can bought and sold in public polls by voting pro or against a post, regardless of the individual identities of the poll takers. The systems and methods in accordance with exemplary embodiments may be designed in a way that the public for the first time may view itself as crowd or public and view and/or receive “real-time” or live numbers. The systems and methods in accordance with exemplary embodiments may additionally provide analysis such as sentiment analyses, info-graphs, or the like. Essentially the systems and methods in accordance with exemplary embodiments may be configured to or designed to allow the public and/or a group of users to witness itself as a crowd, or the like.

Exemplary embodiments of the present disclosure may be configured to comprise a search engine of “real-time” or substantially “real-time” public opinion data collected from anonymous sources in a non-deterministic model wherein the users may change their opinion as many times as they would like and/or retract an answer. Exemplary embodiments of the present disclosure may allow the public for the first time to witness itself and public opinion data in numbers, or the like. In some embodiments, question size may be unlimited or limited in characters. In some embodiments, when the question size is limited by characters, the questions may be limited to between 70 and 210 characters, or the like, for example, 140 characters.

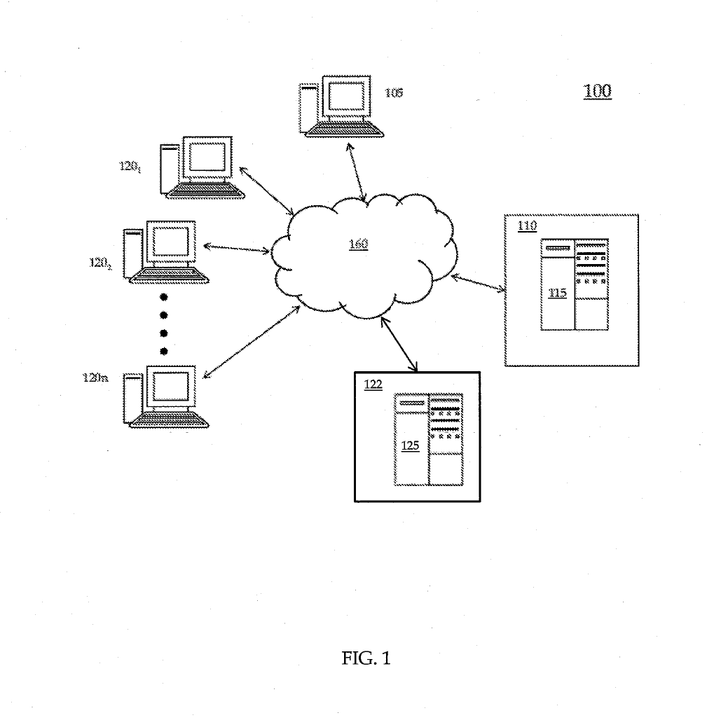

FIG. 1 depicts a system-level network diagram of system of poll initiation and data collection in accordance with one embodiment of the present disclosure. The system 100 generally comprises at least a first user 105 and secondary users 120₁ and 120₂, each in communication with an administrator 110, generally hosting a central server 115 or database, through a network 160, which may comprise a global computer/communication network, for example, the Internet.

As is common in network-based business models, the administrator 110 may also comprise a web administrator, responsible for providing and maintaining a website or interactive portal through which all of the users of the system 100 may interact and execute the methodology and functionality disclosed in the embodiments disclosed herein.

Although FIG. 1 explicitly depicts three secondary users (120₁, 120₂, and 120ₙ), it should be appreciated that “n” represents any number of users feasible in accordance with embodiments of the present disclosure. For ease of reference, as used herein, each of the terms “second user” or “secondary user” may refer to any one or all of the users 120₁, 120₂, and 120_{N} within the system 100. Likewise, although FIG. 1 explicitly depicts only one first user 105, there may be more than one first user 105 in accordance with certain embodiments of the present disclosure. That is, in certain embodiments, multiple users may perform the same or similar functions as the first user 105. As understood by embodiments of the present disclosure, a user may include any person, business or entity, capable of participating in the system and methods disclosed herein.

The first user 105 generally has seeks to initiate a poll and collect data from a statistical population or sub-population. The user 105 may initiate a poll in a variety of formats. By way of example, poll formats may include text, sound, and/or video formats. In some embodiments, a text poll may relate to a question, an opinion, a statement, a perspective, a view, or the like. The data to be collected by the poll may be related to public opinion regarding a particular place, person, age group, object, event, or any question for which the first user 105 desires collecting statistical data. In many embodiments, the method for collecting data may be in accordance with the BEIPO™ method.

In exemplary embodiments, the BEIPO™ method may comprise a collection and/or analysis of opinion data structured within a chaos mathematical model. In some embodiments, the systems disclosed herein allow the first user 105 to initiate a poll on a topic of interest to the first user 105. The interest of the first user 105 may be publicly available. The first user 105 may initiate a poll in text format, or other formats such as sound and/or video. When presented in text format, the poll may relate to opinions, statements, questions, views, and/or the like. The systems disclosed herein may also be adapted to allow the public, which may comprise a secondary user 120, to provide data requested by the poll initiated by the first user 105. The data provided by a secondary user 120 may comprise an opinion of an individual in any statistical population, such as a local, national, and/or global population. In exemplary embodiments, a data collection method may be adapted to provide a live feed of statistical data to a first user, and may comprise a method of capturing BEIPO™ data. In some embodiments, a system may be adapted to provide reports, info-graphs, and live statistics relating to poll data to the first user.

In exemplary embodiments, secondary user(s) 120 may include one or more users in a statistical population provided with a poll initiated by the first user 105. The statistical population may be preconfigured or may be selected by the first user 105. For example, the first user 105 may limit the statistical population to users that live within a local or national geographic region, such as a local region or national region. Alternatively, the first user 105 may set the statistical population as one or more users living in any location, for example, globally. Secondary users(s) 120 may be provided access to the system and allowed to enter data related to the poll initiated by the first user 105. In some exemplary embodiments, the system may be adapted to provide a live feed from public engagement with the system and may comprise a computing device adapted to implement a method for generating BEIPO™ data. A system in accordance with embodiments of the present invention may be adapted to allow a first user 105 to modify parameters of a poll in real time and receive real time data based on the modified parameters.

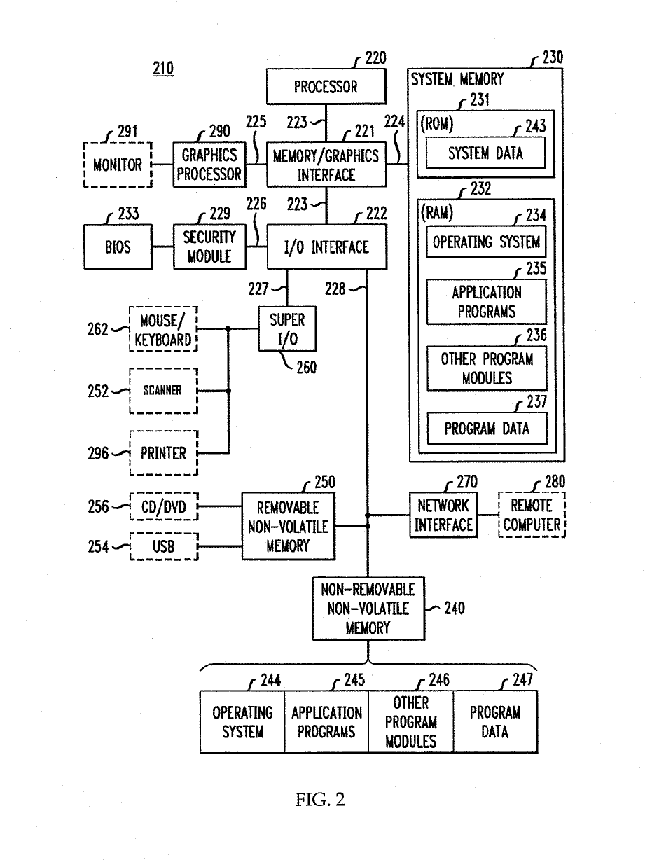

In a basic exemplary embodiment, within the system 100, a first user 105 may be capable of transmitting a request to initiate a poll to the administrator 110, using a computing device. The administrator 110 may then approve or deny the poll request. In some embodiments, the first user 105 may initiate a poll without an administrator's 110 approval. The computing device in the context of this application may include, but is not limited to a mobile device, a personal computer, smartphone, an Apple iPhone, a Blackberry device, Personal Data Assistant (PDA), a netbook, a mobile computer or the like, or may generally include a general purpose computer, or components thereof as discussed below in FIG. 2.

The network 160 may comprise any network suitable for embodiments of the present disclosure. For example, the network 160 may be a partial or full deployment of most any communication/computer/communication network or link, including any of, any multiple of, any combination of or any combination of multiples of a public or private, terrestrial wireless or satellite, and wireline networks or links. The network 160 may include, for example, network elements from a Public Switch Telephone Network (PSTN), the Internet, core and proprietary public networks, wireless voice and packet-data networks, such as 1G, 2G, 2.5G, 3G and 4G, LTE, telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, or the like.

Optionally, a third party 120, generally hosting a commercial server 125 or database, may be in communication with the system 100 through the network 160 to carry out certain features of embodiments of the present disclosure, as explained below. In accordance with embodiments of the present disclosure, such third party commercial servers 125 may be administered by financial institutions (e.g., banks, credit card companies, or the like), advertisers (e.g., any third party offering banner ads or displayed offers), local merchants (e.g., providing information regarding an area or services within an area) social networking sites (e.g., Facebook, MySpace, Twitter, FourSquare or the like), global positioning system administrators, or the like.

In accordance with one embodiment of the present disclosure, any of the administrator or users may comprise a general purpose computer, for example, as shown in the form of a computer 210 depicted in FIG. 2. As appreciated by embodiments of the present disclosure, more practical devices, such as mobile devices, mobile telephones, laptop computers, netbooks, tablet computers, or the like, are likely to be utilized than a general computer 210 for embodiments of the present disclosure. However, it is also appreciated there is a significant similarly in core components between a mobile device, a personal computer, and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In some embodiments, a security module 229 may be incorporated to manage metering, billing, and enforcement of policies. The security module 229 may comprise any known security technology suitable for embodiments disclosed herein.

A super input/output chip 260 may be used to connect to a number of peripherals, such as scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies.

A user may enter commands and information into the computer 210 through input devices such as a mouse/keyboard 262 or other input device combination. Other input devices (not shown) may include a microphone, joystick, game pad, satellite dish, touch screen, fax machine, modem, touch pad, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260. In accordance with exemplary embodiments of the present invention, application programs 245 may comprise software or instructions adapted for use with desktop computers, laptop computers, mobile devices, computing devices, or the like.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer/communication networks, intranets, and the Internet.

In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present disclosure, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. Further, but other commonly known, components for mobile devices and personal computers may also be included in a general computer 210. For example, global positioning chips, wireless communication capability, and related technologies should be included within many embodiments of the present disclosure.

It is understood by embodiments of the present disclosure that a computer, such as the one depicted in FIG. 2, may be connected to a computer/communication network or system. A computer/communication network may include the Internet, a global computer/communication network, a global positioning system, an internal computer/communication network, dedicated server networks, or the like.

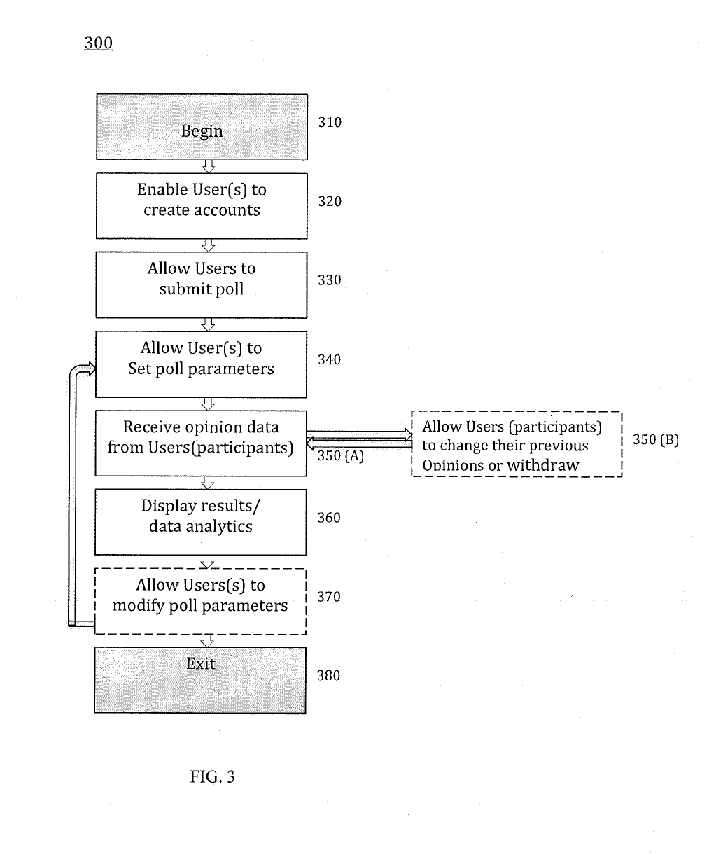

FIG. 3 depicts a flowchart of a method of poll initiation and data collection in a non-deterministic model in accordance with embodiments of the present disclosure. The exemplary method shown depicts a method of engaging users in poll initiation and data collection through a global computer/communication network in accordance with one embodiment of the present disclosure. The method may include initiating and conducting opinion polls and collecting public opinion data from a population or sub-population, independent of traditional third parties (media, campaign managers, academics, or the like). With chaos theory's applications in biology, engineering, and physics, the system in accordance with embodiments of the present invention is based on the application of such theory in determining public opinion.

This dynamic system is highly sensitive to its initial condition, which is a phenomenon known as the “Butterfly Effect,” or when a small change in the initial condition makes a chain of reactions that result in unpredictable outcomes. Butterfly Effect in Public Opinion (“BEIPO”) polling is a direct feeding data collection method that may be imitated by the public and/or registered users. BEIPO™ is based on the “chaos theory” mathematical model, and may take into account that a small change in an initial condition (e.g., the opinion of an individual) of a complex system (for example, the public) may not necessarily result in a small change in the outcome (e.g., public opinion).

The methods disclosed herein may comprise computer readable instructions configured to cause a computing device, or the like, to perform the steps of the methods. For example, the instructions may be adapted and/or configured for use on a computing device, for example, on personal computers, desktop computers, laptop computers, mobile devices, tablets, and/or the like. In one embodiment, the instructions may be downloadable or installed locally on a computing device. In some embodiments, the instructions may be hosted and accessed remotely via a network, for example, the Internet.

The method 300 begins as step 310, wherein a computing device having one or more processors and memory storing one or more programs for execution by the one or more processors may be adapted to perform the functionality of the following steps. It is contemplated that more than one step described may be performed simultaneously or partially simultaneously with other steps. In some embodiments, the system may be adapted to initiate polls and collect data on public opinions/attitudes on a topic chosen by a first user in real time and upon an instruction received from the first user. In some embodiments, the polls may be initiated by individual members of the public, independent of traditional third party pollsters (i.e., news media, academic, campaign organizers, marketing firms, or the like).

At step 320, one or more user accounts may be created by one or more users or entities connected to the system. Generally, each of the user accounts may correspond to one or more entities, whereby an entity may be an individual, a group, or other defined body, such as the first and second users described herein. User registrations may be restricted, for example, to users of a certain age group. In some embodiments, user registrations may be restricted to those who are 18 years old or over.

In some embodiments, access to the system in any capacity may be restricted to only those who are 18 years and older. In some embodiments, user registrations, use of the system, and/or access to the system in any capacity may be open to all age groups. In some embodiments, any user may access the system, whether registered or unregistered and there may be no restrictions on age for access to the system. Data results of the poll(s) described herein may be presented to the public, whether registered or unregistered. More specific analysis and/or customized analysis may also be provided in some embodiments.

Each of the user accounts comprises a plurality of unloadable features as part of a user profile. For example, each of the user accounts may allow for uploading of user or entity-specific characteristics, including basic identification information, race, ethnicity, age, security information (e.g., a user name and password), or the like. Each of such user accounts/profiles may generally be stored as files within a database at the administrator. In many embodiments, when creating a user account, such user may have to subscribe, or otherwise pay for access to the system. In some embodiments, access to the system may not require a fee.

In exemplary embodiments, the system may be adapted to provide a user, whether registered or unregistered, the option of remaining anonymous by protecting the identities and profiles of the users at the time of creation of a poll before a poll has been initiated. The system may also be adapted to allow users to change the anonymity option during polling and in real time. For example, a first user may be provided the option to alternate between showing and hiding the first user's identity and/or profile in real time. The secondary users may also be provided the option of anonymity by protecting the identities and/or profiles of the second users at the time the secondary users provide answers/votes to poll questions. In some embodiments, any user may be provided the option of changing anonymity as many times as desired before or after initiating a poll or providing an answer to a poll.

At step 330, one of the users, for example, the first user, may present a poll for initiation in the system. In some embodiments, poll generation capability may be limited to registered users. The poll may be presented to the general public, including all users, both registered and unregistered. In some embodiments, the poll may comprise a question, which can be in various formats, for example, text, sound, and/or video. The poll may request an opinion related to a person, group, place, object, service, event, and/or the like. For example, the poll may comprise a question requesting an opinion regarding a characteristic of a politician, a sports team, a vacation location, a commercial product, a commercial service, an entertainment event, and/or the like. In many embodiments, a poll may comprise a second question based on an answer received to the first poll question. The second question may request more specific data regarding the answer provided to the first question. Additional tiered questions and/or additional unrelated questions may also be included in the poll. In creating a poll, a user may be asked to select and/or configure a set of poll parameters. The parameters may include geographic and time limitations on the statistical population or sub-population. The system may be adapted to provide users and/or the general public with the ability to view the results of poll data.

At step 340, the parameters of the poll(s) are set by a user. The system may be adapted to allow a user to limit access to the poll to individuals residing in a geographical area, thereby limiting the statistical population for the poll. For example, the system may be adapted to allow a user to limit access to the poll to individuals living in a local, regional, national, or global region. Other limiting parameters, such as non-geographical limitations, may also be received by the system. For example, parameters relating to age, gender, physical characteristics, ethnicity, or the like may be set by the first user.

Parameters of the polls such as time, geographical boundaries of data collection, race, ethnicity, age, etc. may be set by a user and may be changed before, during, or after data collection. In some instances a poll may be marked as “closed” wherein additional responses may not be accepted. A poll may be marked as closed after the expiration of a time period set by a user, after a selected number of entries have been received, and upon request by a user. In some embodiments, parameters and/or user anonymity may be changed before or during a poll, or even after a poll has been marked closed. A user who initiates a poll and those who participate by vote may have the option of being anonymous to the public. The anonymity option can also be changed before or during data collection, or even after data collection. The system may be adapted to allow the user to change the selected area and redefine and/or redistrict the poll before, during, or after polling and in real time, as many times as desired by the a user. The polls may be restricted by the generating user to be limited to those that reside within a pre-defined geographical area. The poll data may be displayed to the public in real time or substantially in real time. In some embodiments, the poll may close during a specified time period or may be posted indefinitely.

Polling time may be configured by a user. The system may be adapted to allow a user to set a period of time the poll will be available to collect data. For example, the system may allow a user to set the time period for a poll to be a day, a few minutes, an hour, a week, a month, a year, or the like, or may be indefinite. The system may be adapted to provide a user the ability to change, by expanding or contracting, a predefined polling time period during polling and in real time, as many times as desired. The system may also be adapted to provide a user the ability to expand pre-defined poling times wherein there is no restriction on polling time (i.e., the polling time is open-ended), as desired by a user.

At step 350(A), the poll may be initiated and data may be received. In exemplary embodiments, the poll may be initiated by transmitting the poll to secondary users and/or the public in accordance with the parameters selected by a user. The poll may generally be transmitted to a computing device and the poll data may be received via a global computer/communication network. In some embodiments, the poll may be transmitted in a physical form, such as a paper survey, and poll data may be inputted into the system when the physical poll is returned. In some embodiments, the poll data may be collected utilizing the BEIPO™ model of collecting opinion data. The system may also be adapted to allow secondary users to change an answer, such as a casted vote, to a poll question, as many times as desired by the secondary user or limited by the system (Step 350(B)). In some embodiments, a user and/or member of the public may be provided the option to withdraw an answer/vote to a poll question previously provided, and to enter a new answer/vote at a later time (Step 350(B)).

At step 360, the poll data received from the secondary users may be analyzed and an analysis may be provided to the first user. The system may provide the analysis to the public and/or to the first user in real time, at intervals selected by the first user, at the completion of the poll at a time selected by the first user, or the like. In some embodiments, the analysis provided to the first user and/or to the general public may comprise one or more of historical data and data generated by use of predictive algorithms on opinion shaping/shifting utilizing data within a larger context of events, policies, and geographical circumstances. In some embodiments, the analysis provided to the first user and/or the general public may comprise live statistical reports and info-graphics/maps for geographical coverage of polling areas. For example, the info-graphics/maps may comprise local, national, or global data. Analysis may be provided based on collected data and other public and private sources.

The analysis may be combined with statistics, info/graphs, and/or maps, and may be within a larger context of social events, policies, and geographical circumstances. The system and/or ticker may provide local, national, and global indices that are available in a variety of formats. In some embodiments, the global and/or regional indices and/or the system may comprise a ticker, similar to the way financial data is displayed. The ticker may comprise tokenized public questions/statements, a sentiment of public opinion, and/or data indices. The system may provide public and/or private indices and/or a ticker that may be displayed in the system or available to be embedded in the websites, communication devices, billboards, or other display formats of additional parties. For example code may be provided to a third party that may integrate the indices and/or tickers generated by the present invention into the third party websites, a billboard, or an alternative display formats adapted to display the indices and or tickers, any of which may be public and/or private. Third parties may also integrate indices and/or tickers generated by embodiments of the present invention in their platforms.

The poll data results and/or analysis may be displayed on/by a communications device. The results/analysis may be displayed in a static format, for example, info-graphs, or the like, and may simply present the results of a specific poll selected by a user or the general public. In other embodiments, indices may be generated and displayed via a ticker-like format, similar to the way financial data can be displayed. The ticker may be displayed at the top of a display of the user, or may be displayed in any location on the display. The indexes may comprise trending or popular polls and/or poll results. For example, ticker may display the most voted upon polls and/or the most discussed polls, and/or the like.

At step 370, the system may optionally provide the first user the ability to modify parameters the first user has previously selected. The system may be adapted to allow the first user to modify the statistical population, the time period for the poll, and/or the like. For example, the first user may choose to change the geographic limitations, or coverage, of the poll and initiate the poll in a larger or smaller geographic area. The user may also chose to change the time period for the poll from one time period to another, for example, one day to one week, or the like. The system may be adapted to receive the updated parameters and return to step 360, where the first user may be provided with updated data analysis based on the updated parameters. The system may be adapted to dynamically provide updated analysis sat any point when the poll is active upon request of the first user. The system may also be adapted to allow a secondary user to change a previously provided poll answer and submit the updated poll data to the system. For example, a secondary user may change a previously submitted answer to a poll question if the poll is still active. If the system receives updated poll data from a secondary user, the data analysis may be updated in real time and provided to the first user, member(s) of the general public, private entities, public entities, or the like, on demand or at predetermined intervals. The exemplary method 300 ends at step 380.

In addition to the exemplary method shown, embodiments of the present disclosure may have numerous additional features to facilitate collection and analysis of poll data. In one embodiment, the system may be adapted to allow messaging between users. For example, the system may be adapted to allow anonymous and non-anonymous messaging, grouping, and communication among users and/or groups of users, whether registered to the system or not registered. In some embodiments, the communications may occur within discussion groups and communities with or without a moderator or moderators. In alternative embodiments, the communications may take place outside discussion groups and communities, for example, via direct messaging.

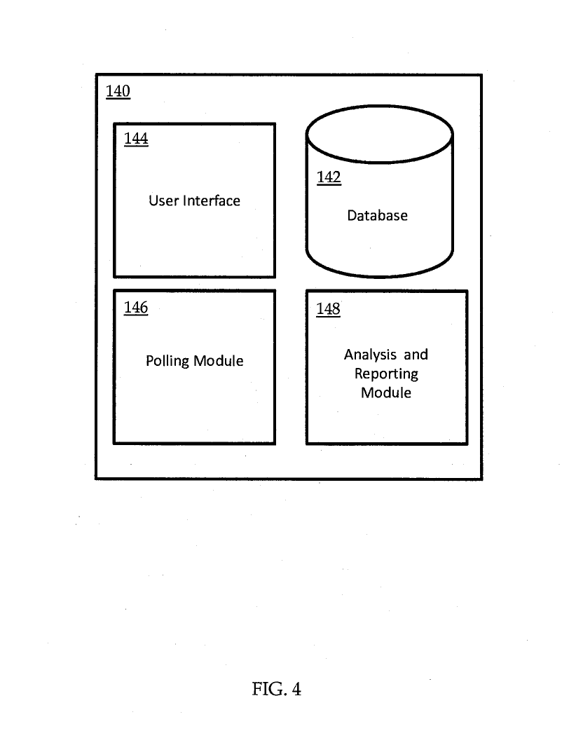

FIG. 4 depicts a block diagram illustrating a system of poll initiation and data collection 140 in accordance with embodiments of the present invention. A system 140 may generally comprise computer executable software and/or instructions configured to perform the functionality of the systems and methods disclosed herein. The system 140 may be stored on a server, on a local computing device, on a mobile communications device, and/or the like. The system 140 may comprise a database 142, a user interface module 144, a polling module 146, an analysis and reporting module 148, and/or the like. In accordance with exemplary embodiments of the present invention, any module may be merged and/or combined with any other module. In some embodiments, additional or fewer modules than those depicted in FIG. 4 may be included.

In exemplary embodiments, the system 140 may be configured to allow a user to initiate and conduct opinion polls and collect public opinion data from a population or sub-population, independent of traditional third parties (media, campaign managers, academics, or the like). With chaos theory's applications in biology, engineering, and physics, the system 140 in accordance with embodiments of the present invention is based on the application of such theory in determining public opinion. This dynamic system 140 may be highly sensitive to its initial condition, which is a phenomenon known as the “Butterfly Effect,” or when a small change in the initial condition makes a chain of reactions that result in unpredictable outcomes. Butterfly Effect in Public Opinion (“BEIPO”) polling is a direct feeding data collection method that may be imitated by the public and/or registered users. BEIPO™ is based on the “chaos theory” mathematical model, and may take into account that a small change in an initial condition (e.g., the opinion of an individual) of a complex system (for example, the public) will not necessarily result in a small change in the outcome (e.g., public opinion). In exemplary embodiments, the term “user” may generally refer to any party provided with access to the systems and methods in accordance with embodiments of the present invention. For example, a user may comprise a member of the public.

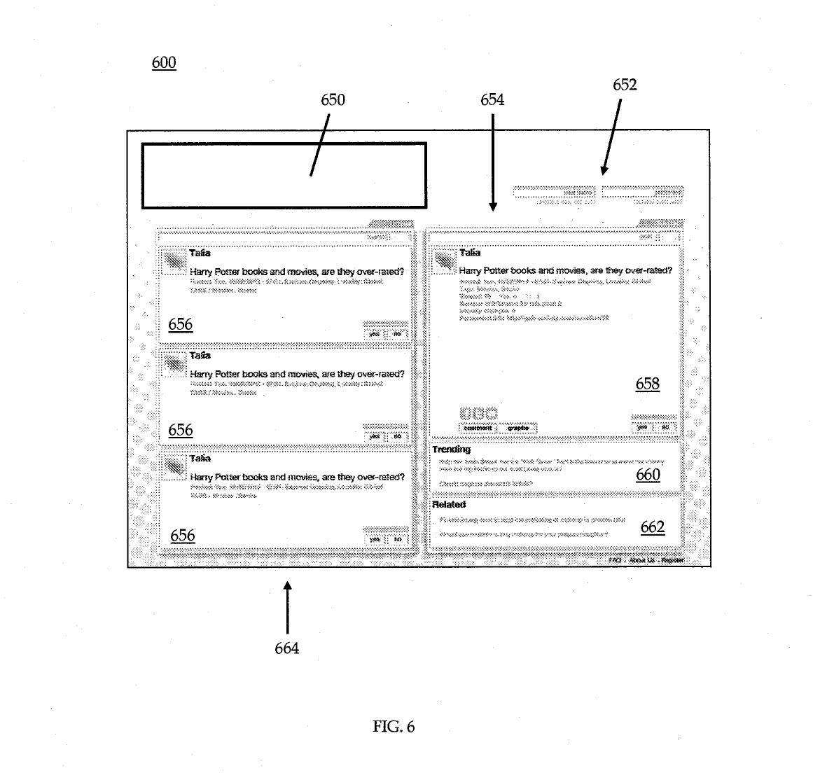

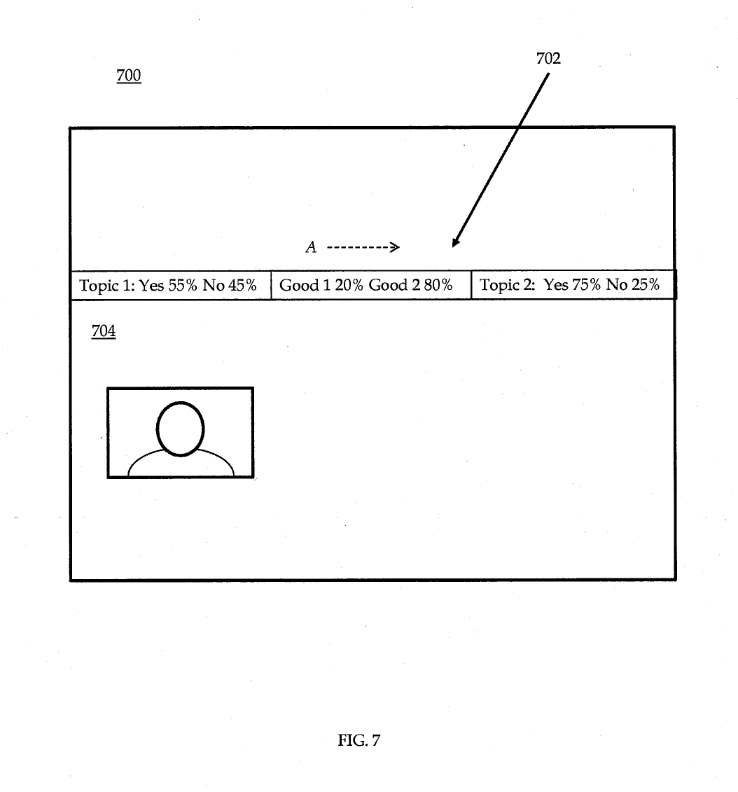

In exemplary embodiments, the interface module 144 may be adapted to provide the user with a means for interacting with the system 140. The interface module 144 may be adapted to present a graphical user interface (GUI) to the user, the GUI adapted to allow users to input, view, and interact with the system 140. In some embodiments, the interface module 144 may be adapted to present real-time or substantially real-time polling data to a user via a display on a computer, a tablet, a mobile device, a laptop, a touchscreen device, and/or the like. Some example user interfaces are depicted in FIGS. 6 and 7. The interface module 144 may also be adapted to provide an opportunity to register a user account for accessing the system 140.

For example, as shown in FIG. 6, the interface module may present a login interface 652 comprising a username interface and a password interface, and/or the like. User accounts may be restricted to authorized personnel and a verification of a user's identity, such as a social security number or the like, may be required. In some embodiments, a user may gain access to the system via the login interface 652 by entering a correct username and/or password in the username interface and the password interface and/or the like. In some embodiments, additional security measures, such as biometric security measures, may be implemented. In some embodiments, users may be granted access to the system anonymously, such that their personal details are not stored by the system and/or accessible to other users, or the like. In some embodiments, the system may store a user's personal details but those personal details may be inaccessible to the public unless the user grants they system access to make the user's personal details publicly accessible.

In some embodiments, a user may create a user profile that may comprise information about the user. For example, a user profile may comprise a user ID, a name, contact information, demographic information, residency information, and/or the like. In some embodiments. A user's profile may be searchable and/or accessible by other users, administrators, entities, and/or the like.

Referring back to FIG. 4, in some embodiments, user account requests must be approved by an administrator of the system 140 and/or may only be created by an administrator. The user interface module 144 may be adapted to allow a user to answer poll questions, modify their answers to poll questions, retract their answers to poll questions, create poll questions, modify poll parameters for poll questions they have created, and search data stored in the database 142 for real-time or substantially real-time public opinion data. The user interface module 144 may be adapted to allow the user to run a report on the data contained in the database 142 with the analysis and reporting module 148 upon request, or the like. For example, a user may access data upon running a report request with the interface module 144.

In exemplary embodiments, the polling module 146 may be adapted to generate polls and receive poll data, public opinion data, and/or the like. In accordance with exemplary embodiments of the present invention, the polling module 146 may be adapted to receive data from a device, such as a computing device or mobile communications device, and/or the like. In exemplary embodiments, poll data may comprise real-time data regarding public opinions and/or the like. In accordance with exemplary embodiments, the database 142 may be adapted to store all poll and/or opinion data in accordance with the present invention.

In exemplary embodiments, the analysis and reporting module 148 may be adapted to receive the public opinion and/or poll data, analyze the data, and generate reports and/or display the public opinion and/or poll data. For example, the analysis and reporting module 148 may be adapted to analyze the data for statistical trends, calculate poll results and percentages of poll votes, or the like. In some embodiments the analysis and reporting module 148 may be adapted to generate a ticker of real-time or substantially real time public opinion data, or the like. The analysis and reporting module 148 may generally be adapted to analyze collected public opinion data and generate reports in accordance with parameters set by an administrator, or the like.

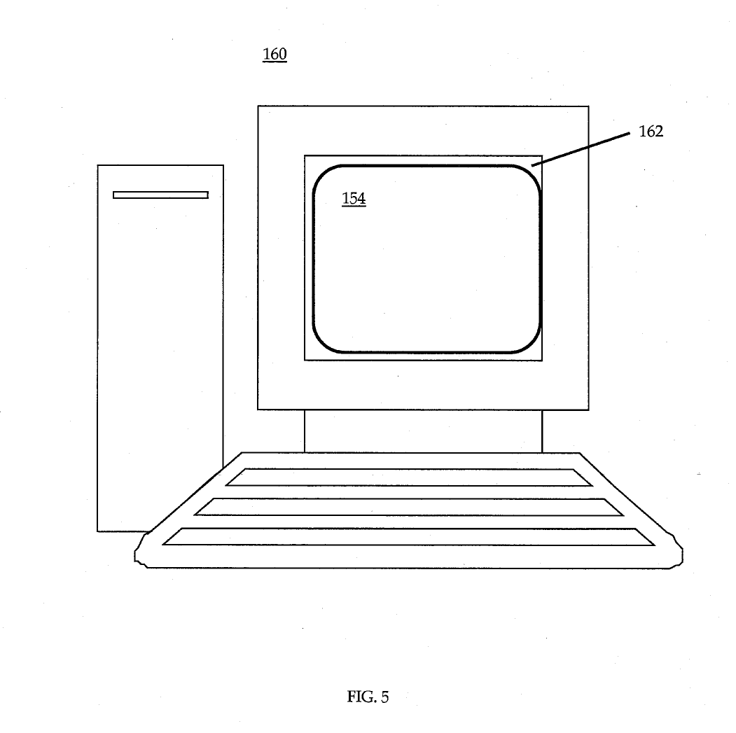

FIG. 5 depicts an exemplary client computer 160 capable of being used with a system of poll initiation and data collection in accordance with embodiments of the present invention. In exemplary embodiments, the client computer 160 may comprise a display 162. The display 162 may be adapted to display at least an interface 154. In exemplary embodiments, the functionality and appearance of the display may be determined by an interface module 144, such as the interface module described with respect to FIG. 4. The interface 154 may be adapted to display any data and analysis collected, stored, and/or analyzed by a system in accordance with embodiments of the present invention. Although a client computer 160 is depicted as a personal computer in FIG. 5, any computing device may be used. By way of example, a mobile phone, a tablet computer, a laptop computer, and/or the like may be used, to name a few.

FIG. 6 depicts an exemplary user interface 600 for use with a system of poll initiation and data collection in accordance with embodiments of the present invention. The user interface 600 may comprise an advertisement portion 650, a login interface 652, a selected data portion 654, and a feed portion 664. In some embodiments, the advertisement portion 650 may be adapted to display an advertisement or a brand name/logo/trademark of the owner or administrator of the system and the user interface 600, or the like. In exemplary embodiments, the login interface 652 may be adapted to allow a user to enter login information and gain access to the system, or the like. In some embodiments, anonymous users without user accounts may be granted access to the system. An exemplary login interface 652 is described, supra.

In some embodiments, the selected data portion 654 may comprise a poll results portion 658, a trending interface 660, a related interface 662, and/or the like. The poll results portion 658 may comprise poll results data for a selected poll question. The poll results portion 658 may comprise the data/time a poll question was posted, when the poll question expires, where the geographic locality of the poll question, any tags or keywords associated with the poll question, a number of times the poll was viewed, the answers to the poll questions, the number of followers of the poll questions, the number of locality changes by a poll creator, a permanent link to the poll question, links to share the poll question on social media platforms such as Facebook, Twitter, and/or the like, a comment button for allowing users to make comments about the poll question, and a graphs button, or the like, adapted to provide statistic about the poll question in a graphical format, and/or the like. In some embodiments, the selected data portion 654 may comprise a search field allowing the user to select a particular poll question after searching for the poll question and after the system returns the search results to the user. In some embodiments, the poll results portion 658 may be displayed after a user selects a polling question in the feed portion 664, or the like.

In some embodiments, the trending interface 660 may present the user with polling questions and/or topics that have received a threshold number of responses in a threshold period of time and/or the like. The trending interface 660 may allow a user to view the most popular topics and/or poll questions in real-time or substantially in real-time. In some embodiments, the related interface 662 may be adapted to display any related questions, public opinion data that may be trending, or the like. In some embodiments, the related interface 662 may query the database in real time and return results and public opinion data that is somehow related, by key term, of the like, to a selected poll question, of the like. As used herein, the term “trending” may refer to a poll question or public opinion data that has crossed a popularity threshold. For example, if a specified number of users answer a specific poll question and/or related poll questions within a specified time, the poll question and/or the related poll questions may be designated as trending, or the like.

In exemplary embodiments, the feed portion 664 may comprise one or more polling questions 656. The feed portion 664 may also comprise a search box and/or interface that allow the user to search for a particular polling question 656. In some embodiments, the polling questions 656 may be presented to the user in order determined by a search performed by the user and/or in order of the most popular and/or trending topics as determined by the system. In exemplary embodiments, the polling questions 656 may be adapted to allow the user to select a polling answer, change a polling answer, retract a polling answer, and/or the like. The system may also be adapted to allow a poll question creator to change certain poll parameters such as limiting the question to a selected geographic area, limiting the duration of the polling question, and/or the like. In some embodiments, the feed portion 664 may be adapted to display polling questions from other users selected by, connected with, or otherwise associated with the user accessing the system to view the feed 664. As such, the feed portion 664 may be adapted to display customized poll questions that are determined to be likely of interest to the user or just a general display of the most popular and/or trending poll questions in real-time or substantially in real-time, or the like.

FIG. 7 depicts an exemplary display 700 comprising a ticker 702 displaying the results of data collected with a system of poll initiation and data collection in accordance with embodiments of the present invention. In exemplary embodiments, the system may be adapted to receive public opinion data and display the public opinion data in real-time or substantially in real-time via a ticker display. The ticker may move as new data is entered in the system in one direction or another, for example, in the direction of arrow A displayed in FIG. 7. The ticker may also be displayed in various other directions or in the various other known methods for displaying ticker data. In some embodiments, the speed of the ticker 702 may be selected by the user and/or determined by the speed at which trending topics and/or poll questions change. The ticker 702 may comprise a “real-time” or substantially “real-time” indication of public opinion on a poll subject that may be taken from anonymous users and initiated in a peer-to-peer method. The ticker 702 may comprise tokenized public questions/statements, a sentiment of public opinion, and/or data indices.

The system may provide public and/or private indices and a ticker 702 that may be displayed in the system or available to be embedded in the websites, communication devices, billboards, or other display formats of additional parties. For example code may be provided to a third party that may integrate the indices and/or tickers generated by the present invention into the third party websites, a billboard, or an alternative display formats adapted to display the indices and or tickers, any of which may be public and/or private.

Third parties, including social networks, for example, may also integrate indices and/or tickers generated by embodiments of the present invention in their platforms. For example the ticker 702 shown in FIG. 7 may be integrated into a social media website 704, or the like. As used herein, the terms “social media” and “social media platform” may refer to any website or application used for social networking or for interaction among people in which the people create, share, and/or exchange information and ideas in virtual communities and/or networks. “Social media” may also refers to any website on which one or more users may post social media content, such as Facebook, Myspace, LinkedIn, Shutterfly, Twitter, Pinterest, and Instagram, to name a few.

While the foregoing is directed to exemplary embodiments of the present disclosure, other and further embodiments of the disclosure may be devised without departing from the basic scope thereof, and should be considered part of this disclosure, as if described fully herein. Specifically, whereas the worldwide web and mobile web are growing content and capabilities at ever-increasing rates, the ability to adapt the systems, methods, applications, and interfaces disclosed herein to existing or new mobile- or web-based technology is contemplated by embodiments of the present disclosure and does not depart the scope of the disclosure disclosed herein.

What is claimed is:

1. A computer-implemented method of public opinion poll initiation and public opinion data collection using a non-deterministic model, the method comprising:
at a server having one or more processors and memory storing one or more programs for execution by the one or more processors:
receiving a public opinion poll post from a first user;
receiving a public opinion poll instruction comprising a locality, age, demographic, from the first user;
initiating the public opinion poll post and displaying the public opinion poll post to a second user, the second user complying with the public opinion poll instruction;
receiving an initial answer to the public opinion poll from the second user;
generating results of the public opinion poll based on the initial answer;
receiving an alternative answer from the second user, the alternative answer different from the initial answer;
updating the results of the public opinion poll based on the alternative answer; and
displaying a real-time feed of the public opinion poll results, the real-time feed updated when public opinion poll answers are entered or changed by the alternative answer.

2. The method of claim 1, further comprising receiving one or more tags from the first user indicating the general subject matter of the public opinion poll question.

3. The method of claim 1, wherein the public opinion poll instruction is defined by geographic area or demographic parameters.

4. The method of claim 1, wherein the public opinion poll question comprises at least one of a text public opinion poll, an audio public opinion poll, and a video public opinion poll.

5. The method of claim 1, wherein the public opinion poll relates to a question, an opinion, a statement, a perspective, and a view.

6. The method of claim 1, wherein the identities of the first user and the second user are not revealed by the system for users wish to maintain anonymity.

7. The method of claim 1, further comprising allowing the first user and the second user to select whether they wish to keep their identity anonymous; and
allowing the users to change their selections of whether they wish to keep their identity anonymous at any point before, during, or after the polls.

8. The method of claim 1, further comprising generating and displaying live reports and info-graphs based on the results of the public opinion poll.

9. The method of claim 1, wherein the real-time feed of the public opinion poll results is displayed in the form of a ticker.

10. The method of claim 1, wherein the public opinion poll must be approved by an administrator prior to being displayed to the second user.

11. A computer-implemented method of public opinion poll initiation and public opinion data collection using a non-deterministic model, the method comprising:
at a server having one or more processors and memory storing one or more programs for execution by the one or more processors:
receiving a public opinion poll from a first user;
receiving a public opinion poll instruction comprising locality, age, and race from the first user;
receiving an expiration time for the public opinion poll from the first user;
initiating the public opinion poll and displaying the public opinion poll to the second user, the second user residing within the public opinion poll instruction;
receiving an initial answer to the public opinion poll from the second user;
generating results of the public opinion poll based on the initial answer;
receiving an alternate answer from the second user, the alternate answer different from the initial answer;
updating the results of the public opinion poll based on the alternate answer;
displaying a real-time feed of the public opinion poll results, the real-time feed updated when public opinion poll answers are entered or changed by a user; and
closing the public opinion poll after the expiration of the expiration time, whereby no additional answers to the public opinion poll are received, changed, or retracted.

12. The method of claim 11, further comprising allowing the first user to reopen the public opinion poll and modify the expiration time of the public opinion poll after the expiration of the public opinion poll.

13. The method of claim 11, wherein the public opinion poll instruction comprises is a defined geographic area.

14. The method of claim 11, further comprising allowing the first user to modify the public opinion poll instruction at any time prior to the public opinion poll expiring.

15. The method of claim 11, further comprising allowing the first user and the second user to select whether they wish to keep their identity anonymous; and
allowing the users to change their selection of whether they wish to keep their identity anonymous before, during, or after the poll.

16. The method of claim 11, further comprising generating and displaying live reports and info-graphs based on the results of the public opinion poll.

17. The method of claim 11, wherein the real-time feed of the public opinion poll results is displayed in the form of a ticker.

18. The method of claim 17, wherein the ticker is embedded in a social media website.

19. A system comprising at least one server, the server comprising:
one or more processors; and memory; wherein the at least one server is adapted to:
receive a public opinion poll from a first user;
receive a public opinion poll instruction from the first user;
initiate the public opinion poll and displaying the public opinion poll to the second user, the second user residing within the public opinion poll instruction;
receive an initial answer to the public opinion poll from the second user;
generate results of the public opinion poll based on the initial answer;
receive a second an alternative answer from the second user, the alternative answer different from the initial answer;
update the results of the public opinion poll based on the second answer; and
display a real-time feed of the public opinion poll results, the real-time feed updated when public opinion poll answers are entered or changed by a user.

20. The system of claim 19, wherein the real-time feed of the public opinion poll results is displayed in the form of a ticker.
